(19) United States
(12) Patent Application Publication
(10) Pub. No.: US 2015/0185749 A1
(43) Pub. Date: Jul. 2, 2015

(54) METHOD FOR OPERATING A SUPPLY NETWORK AND SUPPLY NETWORK

(71) Applicant: SIEMENS AKTIENGESELLSCHAFT, MÜNCHEN (DE)

(72) Inventor: Florian Steinke, Munchen (DE)

(73) Assignee: SIEMENS AKTIENGESELLSCHAFT, MÜNCHEN (DE)

(21) Appl. No.: 14/409,598

(22) PCT Filed: Jun. 18, 2013
(86) PCT No.: PCT/EP2013/062587

§ 371 Date: Dec. 19, 2014

(30) Foreign Application Priority Data
Jun. 21, 2012 (DE) 10 2012 210 509.3

(51) Int. Cl. G05F 1/66; H02J 4/00

(52) U.S. Cl. CPC G05F 1/66; H02J 4/00

(57) ABSTRACT

A method for operating a supply network with network units that provide or consume a resource. Cost functions of the network units are mapped onto local potentials of an undirected graph model. Marginalisation methods or optimisation methods such as belief propagation for stochastic interference minimise an overall cost function for controlling the network units. An accordingly operated supply network with network units is also described. The described method makes it possible, for example, to easily determine a usage plan for power plants as network units in an energy supply network. Condition estimates for networks are also made possible.

### CROSS-REFERENCE TO RELATED APPLICATIONS

This application claims priority to PCT Application No. PCT/EP2013/062587, having a filing date of Jun. 18, 2013, based off of DE 102012210509.3 having a filing date of Jun. 21, 2012, the entire contents of which are hereby incorporated by reference.

### FIELD OF TECHNOLOGY

The following relates to a method for operating a supply network, such as, for example, an energy supply network comprising generators and consumers.

### BACKGROUND

In particular, in energy supply networks with decentralized energy generators and consumers, low-complexity use planning of the power stations available is desired. In corresponding supply networks, a large number of individual energy generators need to be actuated, i.e. run up and run down, and their input into the network needs to be estimated. In addition, the consumers' energy requirement needs to be estimated plausibly. Overall, as efficient utilization as possible of in particular the resource energy and the distribution of the resource within the network is intended to take place. In general, corresponding cost functions for the network nodes or network units in the supply network are established and linked to a target function. This target function is then subject to optimization.

Generally, high-dimensional, nonlinear optimization problems result for this target function in order to determine use planning of the power stations involved in the power supply network. In the past, nonlinear optimization methods such as Lagrangian relaxation, dynamic programming with Hamilton-Jacobi-Bellmann iteration, genetic algorithms, or mixed-integer linear programming (MILP) have been used for this purpose.

Known methods for operating corresponding energy supply networks and determining use plans require a high level of computation power and usually scale superlinearly with the number of network nodes, i.e. the number of power stations or consumers involved. Usually, even global minimization of the target function with the aid of conventional optimization methods cannot be ensured.

An aspect relates to providing an improved supply network and/or an improved method for operating a supply network.

Accordingly, a method for operating a supply network for a resource comprising a plurality of network units which generate or consume the resource is proposed. The network units are coupled to one another for the exchange of the resource. The method comprises:
detecting a resource input or a resource consumption of each network unit and a resource flow parameter for each network unit;
assigning a cost function to each network unit, wherein the cost function is dependent on the resource input or resource consumption of the network unit, and the resource input or resource consumption is dependent on the resource flow parameters of the network unit and the further network units coupled directly to the network unit;
determining a total cost function of the supply network as a sum of all of the cost functions of the network units of the supply network; and
marginalizing the total cost function via the resource flow parameters, wherein the cost functions are mapped onto local potentials of a non-directional graphical model.

In particular, the marginalization comprises minimization of the total cost function via the resource flow parameters, wherein the cost functions are considered to be logarithms of local potentials of a non-directional graphical model. Furthermore, marginalization can also mean the formation of a boundary value distribution for the cost functions interpreted as probability distribution.

In addition, a supply network for a resource which comprises a plurality of network units is proposed. The network units generate or consume the resource and are coupled to one another for the exchange of the resource. The supply network is designed to implement a corresponding method for the actuation and provision of a use planning of the network devices.

The method or the supply network, within the context of nonlinear optimization, makes it possible in particular to operate a supply network efficiently with controllable network units. The resultant target function or total cost function of the supply network can in this case be expressed, for example, as a sum of local terms which describe properties of the individual network units. The cost functions couple to one another in particular by means of nearest neighbor coupling, which is described by the respective resource flow parameter. This makes it possible to use methods for non-directional graphical models for use, for example, in the use planning of power stations in supply networks. It is therefore proposed to map costs and target functions which are generally considered in the context of nonlinear optimization methods onto statistical inference methods in the context of graphical models and thereby to resolve them. As a result, the computation complexity is considerably minimized and therefore low-complexity operation of supply networks can take place.

As an alternative or in addition, in a manner which is favorable in terms of complexity, a state estimation for the supply network can be established by means of marginalization. For example, locally measured resource currents can be used to determine the state of the supply network within the scope of a marginalization method for non-directional graphical models. During the marginalization, in each case the boundary value distribution for each unknown resource flow parameter is determined, by averaging or “integrating out” the respective remaining free variables of the probability model, which is defined by the total cost function.

The resource may be energy, for example, such as electrical energy, but can also be other resources referred to as commodities. This may be, for example, a source of energy such as gas or oil. It is also conceivable for the resource to be computation time or computation power in computer networks. Intermediate products in a production network can also be interpreted as a resource.

A supply network can in this case in particular be understood to mean: a power supply network, a gas supply network, or else building management systems or networks in automation engineering. In embodiments, gases such as inert gases or compressed air in corresponding distribution networks can also be considered. It is desirable for in each case a global minimum of the total cost function to be found.

The network units are in this case, for example, current generators or consumers such as, for example, various power stations which have various cost functions depending on their energy or current generation methods. In this case, it is possible to describe the flow of the resource, such as of the current, for example, in terms of resource flow parameters. For example, in an electricity grid, the current phase of a respective network unit can be used in the conventional DC approximation of the flow equation as resource flow parameter. Owing to continuity considerations, the currents at a respective network unit or the respective input or consumption of the current or the resource at a node, for example, result from the knowledge of the resource flow parameters. The following terms will also be used to mean network unit below: network device, network node, and unit.

In embodiments of the method or the supply network, the minimization of the total cost function further comprises:
performing an optimization method for a non-directional graphical model, in which a probability function is maximized as the product of the local potentials. In this case, the optimization method is selected in particular from one of the groups of optimization methods comprising: belief propagation, loopy belief propagation and junction tree algorithm.

Owing to the locality of the cost functions, namely in particular by description with the aid of the resource flow parameters, algorithms which are known per se for graphical models can be used in order to minimize the total cost function in the case of the supply network. The network topology is in this case preferably described such that there are no loops of a plurality of network units, but the network has a tree structure. For this purpose, couplings or connections which are really present per se for the exchange of resources can be approximated or estimated. It is possible to approximate any desired real network topology which also contains loops by means of a tree structure. However, it is also possible in principle to apply marginalization or optimization methods from the field of graphical models directly to networks which do not have a tree structure.

Preferably, the supply network is designed or modeled in such a way that a respective network unit is preferably coupled to less than a preset maximum number of adjacent network units. In exemplary embodiments, each network unit has at most three adjacent network units to which it is coupled.

In embodiments of the method, the steps of assignment and minimization are performed to establish a network unit use plan over a preset time period for a plurality of times in the time period. For example, the resource consumptions for at least a selection of network units in the supply network are fixed or estimated over the preset time period. Predictions for the consumption of resources, such as current, for example, can be established and corresponding cost functions can be generated in time-dependent fashion. Overall, the optimization method can be performed stepwise, i.e. over a plurality of times, in the time period to be predicted or to be controlled. As a result of the method, values for the current or resource generation of the power stations in the supply network are then provided.

Preferably, the cost function of a respective network unit is minimized successively taking into consideration the further network units which are coupled directly to the network unit via the resource flow parameters. For example, in the method, the cost functions of the network units and locally calculable cost coupling terms are minimized in each case individually via the resource flow parameters which are allocated to the respective network unit and the adjacent network units. In particular as a result of the locality, i.e. the nearest neighbor interaction of the network units with one another, the cost coupling terms can be calculated locally and the cost functions can then be minimized locally.

The cost functions comprise in particular nonlinear components in the resource flow parameters. For example, only piecewise constant cost functions which have nonlinear components result because, for example, power stations can only be operated expediently between a power minimum and a power maximum. In addition, the efficiency of a corresponding power station as network unit can be very dependent on the load.

In embodiments of the method, the network units are controlled depending on the resource flow parameters. By determining sets of resource flow parameters which achieve as minimum a total cost function as possible, energy generation or consumption of individual network devices can be determined in electrical supply networks, for example.

In embodiments of the method, the cost functions are local cost functions, which are dependent exclusively on the resource input or resource consumption of the network unit and/or the resource flow parameters of the network unit and of the further network units which are coupled directly to the network unit.

In particular by description with the aid of only local cost functions, an optimization method can be used efficiently as statistical model for determining a maximum probability for graphical models.

In embodiments, the resource is in particular electrical energy, and the resource input or resource consumption is an electric power of a network unit.

The exchange of a resource is performed via electric current, for example, wherein the resource flow parameter is a phase angle of a current into or out of the respective network unit out of or into the supply network.

Furthermore, a computer program product which initiates the implementation of a corresponding method on a program-controlled device is proposed.

A computer program product such as a computer program means can be provided or supplied, for example, as storage medium, such as memory card, USB stick, CD-ROM, DVD or else in the form of a downloadable file from a server in a network. This can take place, for example, in a wireless communications network by the transmission of a corresponding file with the computer program product or the computer program means. A possible program-controlled device is in particular a control device such as, for example, a master computer for use planning of network units in a supply network.

Furthermore, a data storage medium comprising a stored computer program with commands is proposed, which initiates the implementation of a corresponding method on a program-controlled device.

Further possible implementations of of the invention also include combinations of method steps, features or embodiments of the method or the supply network described above or below with reference to the exemplary embodiments which are not explicitly mentioned. In this case, a person skilled in the art will also add or amend individual aspects as improvements or additions to the respective basic concept of of the invention.

### BRIEF DESCRIPTION

Some of the embodiments will be described in detail, with reference to the following figures, wherein like designations denote like members, wherein:

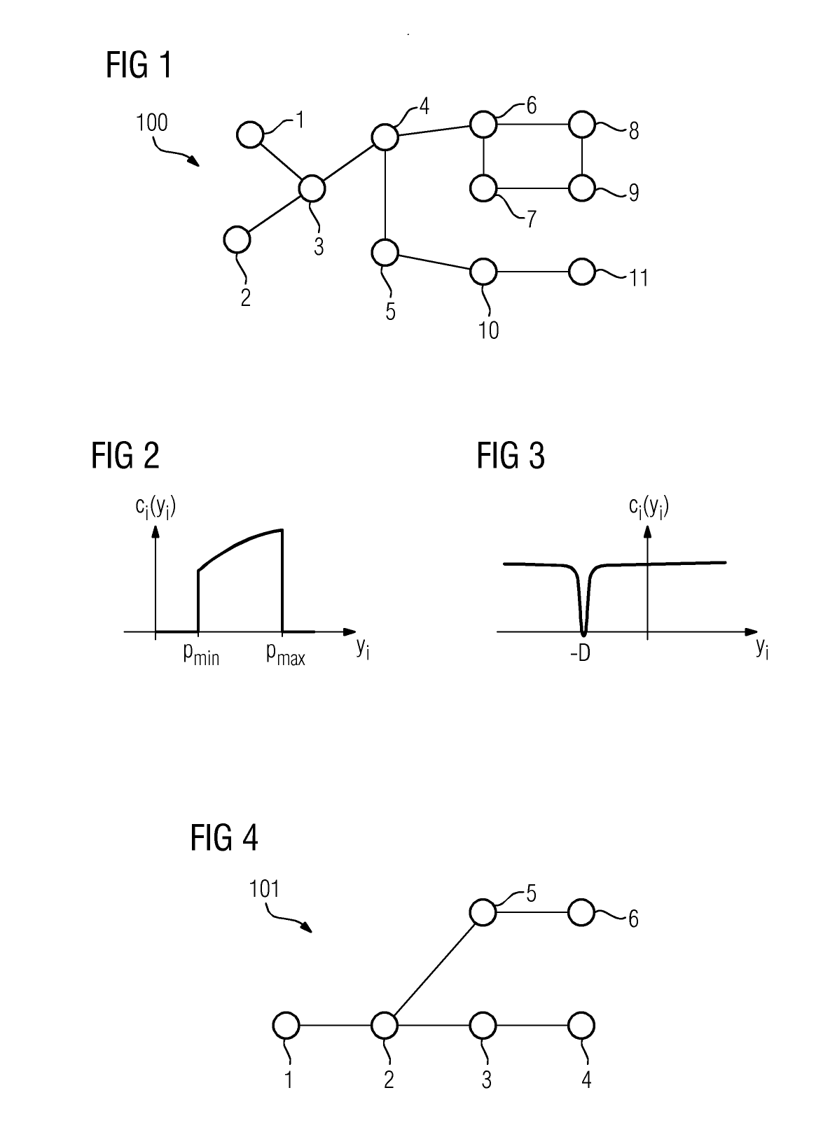

FIG. 1 shows a schematic illustration of an exemplary embodiment of a supply network comprising network units;

FIG. 2 shows an illustration of a possible cost function for a generator as network unit;

FIG. 3 shows an illustration of a possible cost function for a consumer as network unit;

FIG. 4 shows a schematic illustration of a further exemplary embodiment of a supply network comprising network units.

### DETAILED DESCRIPTION

FIG. 1 shows a schematic illustration of an exemplary embodiment of a supply network comprising network units. The supply network 100 has in this case network units 1-11, which correspond to energy sources and energy sinks, for example. That is to say that, in the case of an electrical supply network, in particular current consumers, but also current generators, such as power stations, for example, are present. The participants in the supply network 100, which are referred to as network units or else nodes 1-11, are coupled to one another via lines, for example, which are illustrated by edges in FIG. 1. For example, the network unit 1 may be a consumer, such as a factory, for example, which is coupled to the remaining network nodes 2-11 present in the network 100 via the network node 3. The edges in this case represent the fact that the resource to be distributed, such as current, for example, can flow.

In particular in the case of modern supply networks for energy, many distribution power stations, for example for wind power, water power, gas, coal, atomic power or solar energy, are interconnected. In order to provide the generated energy and energy requested by consumers in the supply network 100 in a manner which is as cost-efficient as possible, use planning of the power stations provided is necessary. This is generally performed by the allocation of cost functions to the network units 1-11 present in the supply network 100.

In the explanations below, it is assumed by way of example that the supply network is an energy supply network for electric current. To this extent, the resource is electrical energy, which is distributed via electric current in the network via lines, by means of which the participants, i.e. current generators and consumers, are coupled to one another.

FIG. 2 illustrates a possible form of a cost function cᵢ for an energy-generating device, for example. Current generation yᵢ in arbitrary units is plotted on the x axis, and a corresponding cost function cᵢ (yᵢ) is plotted on the y axis in arbitrary units. In the case of a power station, the cost function is not constant between a minimum current generation Pₘᵢₙ and a maximum current generation Pₘₐₓ, for example. Instead, owing to the efficiency and operating point of a corresponding current generation power station, a nonlinear form of the cost function cᵢ (yᵢ) results. In order to determine use planning, a corresponding cost function is allocated to each current generator in the network 100.

FIG. 3 shows a cost function for a consumer in the supply network. The corresponding current consumption yᵢ is in this case associated with a cost function cᵢ (yᵢ), which is plotted on the y axis. A consumer requires an electric power —D at a preset time, for example. Therefore, the cost function for the corresponding consumer has a minimum of yᵢ=−D. D is also referred to as demand.

In particular in the case of an electricity supply network, the energy input or the energy consumption from the current phase present at the node can be determined on the basis of continuity equations at each network node, i.e. each generator or consumer in the network, using a known DC approximation of the load flow equations. A target function or total cost function for the network at a preset time results from the sum of the cost functions for all network nodes or current consumers or current generators. It is now desirable to minimize this target function in order to determine the most favorable operating parameters, i.e. current consumer and current generators, for example in the context of phase angles. This results in a particularly favorable capacity utilization of the network infrastructure and a minimum degree of complexity for all network participants.

The use planning or optimization of the operation of a corresponding supply network will be explained below with reference to a simplified schematic network, as illustrated in FIG. 4. In this case, FIG. 4 shows a supply network 101 which distributes electrical energy, for example. In this case, six nodes 1-6 are provided, which are each coupled to one another via edges, i.e. electrical lines. The node 1 is coupled to the node 2. The node 2 is coupled to the node 1, the node 5 and the node 3. The node 3 is coupled to the node 2 and the node 4, and the node 4 is only coupled to the node 3. The node 5 is coupled to the node 2 and the node 6, and the node 6 is only coupled to the node 5. In this case, the nodes can be current-feeding network units or current-consuming network units, depending on their cost function.

A cost function cᵢ is allocated to each node, wherein the index i=1, . . . 6 denotes the respective node or the network unit i. The desired optimization now consists in finding a global minimum for the following expression:

$${min}_{y , δ} {\sum }_{i} {C}_{i} ( {y}_{i} ) , where {y}_{i} = {\sum }_{j} {B}_{ij} {δ}_{j} . \qquad ( Eq . 1 )$$

In this case, cᵢ is the respective cost function of the i-th node, yᵢ is the energy consumption or energy input of the i-th node, δᵢ is a current phase angle at the i-th node, and the matrix Bᵢⱼ describes the coupling of the adjacent nodes to one another. The phase angle δᵢ corresponds to a resource flow parameter, which determines the inflow and/or outflow of electric current in the electricity supply network in the case of an electricity supply network. The edges or couplings between the nodes can be understood as electrical lines.

In principle, a nonlinear and high-dimensional optimization problem results over the phase angle δᵢ. Owing to continuity equations, however, only closest neighbor interactions result, i.e. couplings between locally adjacent nodes, and a description of the coupling is performed by the respective phase angles as resource flow parameters of adjacent nodes. The cost function for the node i=2 is in this case dependent only on the phase angles δ₁, δ₂, δ₃, δ₅, for example. To this extent, the following minimization problem can be formulated for the network illustrated in FIG. 4:

$${min}_{{δ}_{1} … {δ}_{6}} [ {c}_{1} ( {δ}_{1} , {δ}_{2} ) + {c}_{2} ( {δ}_{1} , {δ}_{2} , {δ}_{3} , {δ}_{5} ) + {c}_{3} ( {δ}_{2} , {δ}_{3} , {δ}_{4} ) + {c}_{4} ( {δ}_{3} , {δ}_{4} ) + {c}_{5} ( {δ}_{2} , {δ}_{5} , {δ}_{6} ) + {c}_{5} ( {δ}_{5} , {δ}_{6} ) ] \qquad ( Eq . 2 )$$

Owing to the locality of the interaction of the nodes with one another, equation 2 can be simplified. Using

$${min}_{a , b} f ( a , b ) = {min}_{a} [ {min}_{b} f ( a , b ) ] ,$$

Equation 2 can be written as follows:

$${min}_{{δ}_{1} , {δ}_{2}} {c}_{1} ( {δ}_{1} , {δ}_{2} ) + {min}_{{δ}_{3} , {δ}_{5}} {c}_{1} ( {δ}_{1} , {δ}_{2} , {δ}_{3} , {δ}_{5} ) + {min}_{{δ}_{1}} [ {c}_{3} ( {δ}_{2} , {δ}_{3} , {δ}_{4} ) + {c}_{4} ( {δ}_{3} , {δ}_{4} ) ] + {min}_{{δ}_{L}} [ {c}_{5} ( {δ}_{2} , {δ}_{5} , {δ}_{6} ) + {c}_{6} ( {δ}_{5} , {δ}_{6} ) ] = {min}_{{δ}_{1} , {δ}_{2}} {c}_{1} ( {δ}_{1} , {δ}_{2} ) + {min}_{{δ}_{2} , {δ}_{5}} {c}_{2} ( {δ}_{1} , {δ}_{2} , {δ}_{3} , {δ}_{5} ) + {min}_{{δ}_{4}} [ {c}_{3} ( {δ}_{2} , {δ}_{3} , {δ}_{4} ) + {m}_{34} ( {δ}_{3} , {δ}_{4} ) ] + {min}_{{δ}_{6}} [ {c}_{5} ( {δ}_{2} , {δ}_{5} , {δ}_{6} ) + {m}_{65} ( {δ}_{6} , {δ}_{5} ) ] = {min}_{{δ}_{1} , {δ}_{2}} {c}_{2} ( {δ}_{1} , {δ}_{2} ) + {min}_{{δ}_{2} , {δ}_{4}} {c}_{2} ( {δ}_{1} , {δ}_{2} , {δ}_{3} , {δ}_{5} ) + {m}_{32} ( {δ}_{3} , {δ}_{2} ) + {m}_{52} ( {δ}_{5} , {δ}_{2} ) ] = {min}_{{δ}_{1} , {δ}_{2}} {c}_{1} ( {δ}_{1} , {δ}_{2} ) + {m}_{21} ( {δ}_{2} , {δ}_{1} ) \qquad ( Eq . 3 )$$

In this case, the local cost coupling terms my are determined as follows:

$${m}_{ij} ( {δ}_{i} , {δ}_{j} ) = {min}_{{δ}_{2} , z ∈ {N}_{1} , z \neq j} {c}_{i} ( {δ}_{i} , {δ}_{j} , {δ}_{2} ) + {\sum }_{z ∈ {N}_{1} , z \neq j} {m}_{zi} ( {δ}_{1} , {δ}_{2} ) . \qquad ( Eq . 4 )$$

The optimum resource flow parameters then generally result from:

$${δ}_{1}^{′} = arg {min}_{{δ}_{1}} {min}_{{δ}_{2} , z ∈ {N}_{1}} {c}_{i} ( {δ}_{i} , {δ}_{j} , {δ}_{z} ) + {\sum }_{z ∈ {N}_{i}} {m}_{zi} ( {δ}_{i} , {δ}_{z} ) . \qquad ( Eq . 5 )$$

In this case only low-dimensional minimization problems result. For example, the possible combinations at a respective node can be counted in order to determine the most favorable δ₁, . . . δ₆. The optimization of a corresponding supply network constructed on the basis of local cost functions and the necessary computation power only increase linearly with the number of nodes present in the network. Each edge in the network is taken into consideration at most twice, for example the edge or coupling between the nodes 3 and 4 is only taken into consideration to calculate m₃₄ and m₄₃. Preferably, the network topology is constructed in the form of a tree, i.e. there are no closed loops. In principle, a precise optimization solution for a corresponding supply network can then be found.

The applicant has now found that the target function or total cost function for a corresponding supply network, as is specified in equation 2, can be mapped onto a graphical model. For non-directional graphical models, stochastic methods for determining a maximum probability as optimization task are known. The illustrated algorithm corresponds to the known statistical method “belief propagation”.

In order to explain the method for determining the most favorable phase angles for the individual nodes, first a probability function for a non-directional graphical model is specified, which can be factorized into local potentials:

p(₁,x₂,x₃,x₄,x₅,x₆)=Ψ₁(x₁,x₂,x₃)Ψ₂(x₁,x₂,x₃,x₅)Ψ₃(x₂,x₃,x₄)×Ψ₄(x₃,x₄)Ψ₅(x₂,x₅,x₆)Ψ₆(x₅,x₆) (Eq. 6)

In this case, p is a probability function, ψᵢ are the local potentials, and xᵢ are random variables. This is also referred to as a probability distribution of a Markoff random field (MRF). Owing to the locality of the potentials, the probability p can be represented correspondingly as a product. In the case of the tasks of stochastics and the use of graphical models, the respective greatest probability is desired. To this extent, an optimization task results as follows:

$${max}_{{x}_{1} , … {x}_{N}} p ( {x}_{1} , … {x}_{N} ) \qquad ( Eq . 7 )$$

Finding the maximum of p is equivalent to the optimization of the following expression:

$${min}_{{x}_{1} , … {x}_{N}} - log p ( {x}_{1} , … {x}_{N} ) = {min}_{{x}_{1} , … {x}_{N}} {\sum }_{j} - log {Ψ}_{j} ( {x}_{1} , … {x}_{N} ) \qquad ( Eq . 8 )$$

Graph algorithms for optimization can be used for this problem. In particular, belief propagation algorithms are known. By comparison of the expressions from equation 8 with the target function, as is specified in equation 2 for the supply network 101, this total cost function can be mapped onto a logarithm of a corresponding local potential for a graphical model. To this extent, the following can be written:

−logΨⱼ(x₁, . . . )=cᵢ(δ₁, . . . ) (Eq. 9)

In particular, mapping of the local potential functions ψⱼ onto the c-j-th power of e takes place:

Ψⱼ→e^{c}^{₁},

and mapping of the random variables x; onto the phases 8; takes place:

ᵢ→δᵢ.

To this extent, by solving an optimization task for non-directional graphical models, a simple solution for the minimization of the target function, i.e. the total cost function, for a supply network can be determined. If a selection of the δᵢ, for example of consumers, for a sequence of times of an operating time period for the supply network are known, the power stations or nodes can be activated or deactivated correspondingly, with the result that, overall, optimal operation of the supply network takes place.

For optimization tasks for non-directional graph models, efficient algorithms and methods are known. For example, a tree algorithm of the OWM MATLAB Toolbox for the simulation program MATLAB can be used for the optimization task for the supply network in figure 4. In this case, a belief propagation method is used. In particular, the transfer to a tree structure for the supply network makes it possible to use known algorithms for optimization, such as belief propagation. The following algorithms from OWM MATLAB Toolbox, which can be called up under http://www.di.ens.fr/˜mschmidt/Software/UGM.html and which can be used are mentioned merely by way of example: junction (precise decoding of graphs with a tree structure), LBP (approximate decoding on the basis of maximum product loopy belief propagation), TRBP (approximated decoding of max product tree re-weighted belief propagation), Linprog (approximate decoding using linearly programmed relaxation). Further efficient algorithms for processing non-directional graphical models can be used.

Possible cost functions C; for the network units 1-6 of the network 101 shown in FIG. 4 are, by way of example:

using

$${y}_{1} = {\sum }_{j} {B}_{i , j} {δ}_{j} ,$$

the following cost structure is assumed for the generator nodes i=2, . . . 5:

cᵢ(y₁)=c₁₀\sqrt{yᵢ}for yᵢ=0 or yᵢ∈[2,4], where c₁₀=const

and

cᵢ(yᵢ)=∝ otherwise,

Bᵢⱼ=1, and c₂₀=4, c₃₀=4, c₄₀=3, c₅₀=2. For the consumption nodes i=1,6 c₁(y₁)=0 holds true if yᵢ=−2 and cᵢ(yᵢ)=∝ otherwise.

The application of a belief propagation algorithm to the supply network 101 using the above cost functions cᵢ produces, for example, in the case of a scale of from −4 to +4 for the consumption yᵢ or an energy generation and preset consumers y₁=−2, and y₆=−2, i.e. in each case an energy consumption for the nodes 1 and 6, the result that the current generation x₂, x₃ and x₄ are equal to zero and x₅=4. This results in a current generator as network unit 5 with the power x₅=4 being the most favorable in the case of a corresponding consumption configuration. The optimization additionally gives x₂=x₃=x₄=0.

Overall, mapping the target function or total cost function of a supply network with nearest neighbor coupling onto a non-directional graphical model results in a simplified optimization task. It is possible in particular to determine a global minimum for the cost function. In the proposed optimization method, the complexity increases only linearly with the number of nodes used in the network. Conventional optimization methods are usually exponentially complex in this case. If there are no loops in the network, but rather there is a tree structure, a global optimal solution results.

As an alternative or in addition, a state estimation can be performed in a manner which is favorable in terms of complexity instead of minimization of the cost function by optimization. For example, locally measured resource currents can be used to determine, as part of a marginalization method for non-directional graphical models, the state of the supply network. In the case of marginalization, the boundary value distribution for each unknown resource flow parameter is determined in each case, by averaging/“integrating out” the respectively remaining free variables of the probability model, which is defined by the cost function.

The aspects and method steps for optimization or minimization described by way of example are in this case special cases of marginalization. Utilizing the locality properties, a similar algorithm results here:

$${m}_{ij} ( {δ}_{i} , {δ}_{j} ) = {\sum }_{{δ}_{2} , z ∈ {Z}_{1} , z \neq z}^{ } ( exp ( {c}_{i} ( {δ}_{i} , {δ}_{j} , {δ}_{z} ) ) {\prod }_{2 ∈ ∉ , z \neq z} {m}_{zi} ( {δ}_{i} , {δ}_{z} ) \\ and p ( {δ}_{i} ) ∝ {\sum }_{{δ}_{1} , z ∈ {N}_{1}}^{ } exp ( {c}_{i} ( {δ}_{i} , {δ}_{j} , {δ}_{z} ) ) {\prod }_{z ∈ {N}_{2}^{1}}^{ } {m}_{zi} ( {δ}_{i} , {δ}_{z} ) \qquad ( Eq . 11 )$$

One application of the state estimation is, for example, in the case of the presence of power stations which do not provide real-time data for their current feed in electricity supply groups. For example, solar power stations provide different powers depending on the radiation intensity, which results in varying voltages on the network. A state estimation can provide the probability for critical voltage states in the supply network depending on measured currents at known network nodes, for example.

Although the invention has been illustrated and described in detail by the preferred exemplary embodiment, the invention is not restricted by the disclosed examples and other variations can be derived from this by a person skilled in the art without departing from the scope of protection of the invention.

1. A method for operating a supply network for a resource comprising a plurality of network units, which generate or consume the resource, wherein the plurality of network units are coupled to one another for an exchange of the resource, said method comprising:
detecting a resource input or a resource consumption of each network unit of the plurality of network units and a resource flow parameter (δᵢ) for each network unit of the plurality of network units;
assigning a cost function (cᵢ) to each network unit of the plurality of network units, wherein the cost function (cᵢ) is dependent on the resource input or resource consumption of the network unit, and the resource input or resource consumption is dependent on the resource flow parameters (δᵢ) of the network unit and the further network units coupled directly to the network unit;
determining a total cost function (c) of the supply network as a sum of all of the cost functions of the plurality of network units of the supply network;
minimizing the total cost function (c) via the resource flow parameters (δᵢ), wherein the cost functions (cᵢ) are mapped onto local potentials (ψᵢ) of a non-directional graphical model; and
controlling the plurality of network units depending on the resource flow parameters (δᵢ).

2. The method as claimed in claim 1, wherein the minimization comprises the following steps:
performing an optimization method for a non-directional graphical model, in which a probability function p(ψᵢ . . . ) is maximized as the product of the local potentials (ψᵢ), wherein the optimization method is selected from the group of optimization methods comprising: belief propagation, loopy belief propagation and junction tree algorithm.

3. The method as claimed in claim 1, wherein the steps of assignment and minimization are performed to establish a network unit use plan over a preset time period for a plurality of times in the preset time period.

4. The method as claimed in claim 3, wherein resource consumptions for at least a selection of the plurality of network units over the preset time period are fixed.

5. The method as claimed in claim 1, wherein the cost function (cᵢ) of a respective network unit is minimized taking into consideration the further network units which are coupled directly to the network unit via the resource flow parameters (δᵢ).

6. The method as claimed in claim 1, wherein the cost functions (cᵢ) are nonlinear in the resource flow parameters (δᵢ).

7. The method as claimed claim 1, wherein the cost functions (cᵢ) are local cost functions, which are dependent exclusively on the resource input or resource consumption of the network unit and/or the resource flow parameters (δᵢ) of the network unit and of the further network units which are coupled directly to the network unit.

8. The method as claimed claim 1, wherein the supply network is designed in such a way that there are no closed loops of network units coupled to one another.

9. The method as claimed in claim 1, wherein the resource is electrical energy, and the resource input or resource consumption is an electric power.

10. The method as claimed in claim 1, wherein an exchange of the resource between the plurality of network units takes place via an electric current, and wherein the resource flow parameter is a phase angle of a DC approximation of a load flow into or out of the respective network unit out of or into the supply network.

11. The method as claimed in claim 1, wherein at least a selection of the plurality of network units are controllable power stations for current generation.

12. A supply network for a resource, the supply network comprising a plurality of network units, which generate or consume the resource, wherein the plurality of network units are coupled to one another for an exchange of the resource, and the supply network is designed to implement a method as claimed in claim 1 for the actuation of and for use planning of the network devices.

13. A computer program product, which initiates an implementation of a method as claimed in claim 1 on a program-controlled device.

14. A data storage medium comprising a stored computer program with commands which initiate an implementation of a method as claimed in claim 1 on a program-controlled device.
